(19) United States
(12) Patent Application Publication
(10) Pub. No.: US 2025/0176073 A1
(43) Pub. Date: May 29, 2025

(54) HEATING ELEMENT ASSEMBLY OF HOT AIR GUN, AND HOT AIR GUN

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 18/926,913

(22) Filed: Oct. 25, 2024

(30) Foreign Application Priority Data
Nov. 29, 2023 (CN) 2023232654691

(51) Int. Cl. H05B 3/16; H05B 3/44

(52) U.S. Cl. CPC H05B 3/16; H05B 3/44; H05B 2203/022

(57) ABSTRACT

A heating element assembly of a hot air gun and such a hot air gun, which relate to power tools. The heating element assembly includes a heating element holder, a heating element, and an air outlet cover; the heating element holder being provided with a plurality of mounting slots distributed at intervals along a circumferential direction, the heating element including a plurality of segments of helical heating bodies and connection sections configured to connect respective neighboring two segments of heating bodies, the heating bodies being disposed in respective mounting slots, at least some of the connection sections being disposed at a front end of the heating element holder; the heating element holder further includes a limiting cover disposed at the front end of the heating element holder and located rear to the air outlet cover, the limiting cover being configured to limit the heating element.

### FIELD

The present disclosure relates to power tools, and more particularly relates to a heating element assembly of a hot air gun, and further relates to a hot air gun adopting this heating element assembly.

### BACKGROUND

A heating element assembly is an important component of a hot air gun. The heating element assembly comprises a heating wire that is energized to produce heat, and an electric motor that actuates a fan to rotate to create an air stream, the air stream passing through the heating element assembly to form a stream of hot air, the stream of hot air serving to solder a component, desolder a component, strip off old paint from a metal surface, remove a self-adhesive sticker, heat a packaging film, heat a packing tube, and the like. To enhance hot air effect, existing heating element assemblies often adopt a structure featuring a plurality of segments of helical heating wires distributed at intervals along a circumferential direction. The plurality of segments of helical heating wires may be formed by a long heating wire coiled into segments, thereby reducing the workload of assembling the plurality of segments of heating wires. However, the heating wires would be expanded and deformed after being energized and heated, while the expanded heating wires might be displaced to contact a front-end air outlet cover causing the latter to become over hot, so that if a user accidentally touches the air outlet cover, he/she would be easily scalded, with no operational safety guaranteed.

### SUMMARY

To overcome the drawbacks in conventional technologies, the disclosure provides a heating element assembly of a hot air gun, in which a limiting cover configured to limit a heating element is provided at a front end of a heating element holder; the disclosure enhances positional stability of the heating element and prevents the heat-induced expanded heating element from displacement to contact an air outlet cover leading to overheat of the air outlet cover, whereby use safety is enhanced.

A heating element assembly of a hot air gun according to the disclosure comprises a heating element holder, a heating element disposed on the heating element holder, and an air outlet cover arranged in front of the heating element holder, the heating element holder being provided with a plurality of mounting slots distributed at intervals along a circumferential direction, the heating element comprising a plurality of segments of helical heating bodies and connection sections configured to connect respective neighboring two segments of heating bodies, the heating bodies being disposed in respective mounting slots, at least some of the connection sections being disposed at a front end of the heating element holder, wherein the heating element assembly further comprises a limiting cover disposed at the front end of the heating element holder and located rear to the air outlet cover, the limiting cover being configured to limit the heating element.

In some implementations, the limiting cover is provided with protrusion portions extending outwardly, and the connection sections disposed at the front end of the heating element holder are limited between respective protrusion portions and the front end of the heating element holder.

In some implementations, the heating element holder is provided with separation bars arranged between respective neighboring two mounting slots, a front end of each separation bar being formed with a rearwardly recessed limiting recess, and the connection sections at the front end of the heating element holder are limited in corresponding limiting recesses by respective protrusion portions.

In some implementations, a projection of each protrusion portion in a front-rear direction is located within a range of a projection of the corresponding separation bar in a front-rear direction.

In some implementations, the heating element assembly further comprises an insulating plate secured to a rear end of the heating element holder, the limiting cover being secured to the insulating plate via a fastener.

In some implementations, a through hole is formed in the center of the heating element holder, and the limiting cover is formed with a fastening hole corresponding to the through hole, the fastener being inserted in the through hole, a rear end of the fastener being secured to the insulating plate, and a front end of the fastener passing through the fastening hole and being bent to abut against the limiting cover.

In some implementations, a locating portion is provided at one of a rear end surface of the limiting cover and a front end surface of the heating element holder, and a locating groove fitted with the locating portion is provided at the other one of the rear end surface of the limiting cover and the front end surface of the heating element holder, the locating portion being inserted in the locating groove.

In some implementations, the heating element assembly comprises a thermocouple extending through the heating element holder, a front end of the thermocouple being limited between the heating element holder and the limiting cover and extending outwardly beyond the limiting cover.

In some implementations, the heating element assembly further comprises a fuse connected in series to the heating element; and/or, the heating element assembly further comprises a Negative Temperature Coefficient NTC protector.

The disclosure further provides a hot air gun, comprising an electric motor and a fan, the electric motor and the fan being disposed in a housing, the fan being actuated by the electric motor, wherein the hot air gun further comprises the heating element assembly as stated supra, the heating element assembly being disposed in the housing and located in front of the fan.

With the above technical solutions, the disclosure offers the following benefits:
1. The heating element assembly of a hot air gun according to the disclosure is provided with a limiting cover at a front end of the heating element holder, the limiting cover being located rear to the air outlet cover, which limits the heating element in a front-rear direction, whereby positional stability of the heating element is enhanced; this prevents the heat-induced expanded heating element from displacement to contact the air outlet cover leading to overheat of the air outlet cover, thereby preventing a user from being scalded due to accidentally touching the over hot air outlet cover, further preventing safety hazards during operating of the hot air gun and enhancing use safety thereof.
2. The connection sections at the front end of the heating element holder are limited between respective protrusion portions and the front end of the heating element holder; the protrusion portions of the limiting cover allow for the connection sections of the heating element to be limited in the front-rear direction, whereby respective neighboring two segments of heating bodies joined via the connection sections are limited in the front-rear direction. By reasonably setting a limiting fitting structure between the limiting cover and the heating element, the impact of the limiting cover on the heating bodies is reduced while the positional stability of the heating element is enhanced.
3. By arranging limiting recesses at the front end of the separation bars, the connection sections at the front end of the heating element holder are limited in the corresponding limiting recesses by respective protrusion portions of the limiting cover; by limiting the connection sections in the space formed by fitting between the limiting recesses and the limiting cover, the connection sections may not be pressed by the limiting cover and thus may not be deformed; in addition, the limiting cover may be substantially conformingly fitted with the front end surface of the heating element holder, whereby structural stability of the limiting cover is enhanced.
4. The projections of the protrusion portions in the front-rear direction are within the range of the projections of the separation bars in the front-rear direction, i.e., the outer contour lines of the protrusion portions do not extend beyond the outer contour lines of the separation bars, which prevents the protrusion portions from blocking the stream of hot air flowing out of the mounting slots, allowing for the stream of hot air to flow out smoothly.
5. By securing the limiting cover to the insulating plate via a fastener, a need of creating an additional hole on the heating element holder to secure the limiting cover is eliminated, which ensures structural strength of the heating element holder. Furthermore, the fastener is inserted in the through hole of the heating element holder, the rear end of the fastener is secured to the insulating plate, and the front end of the fastener extends through the fastening hole on the limiting cover and is bent to abut against the limiting cover; by reasonably setting the specific structure of the fastener, the limiting cover may be stably secured to the front end of the heating element holder.
6. The locating portion and the locating groove which are fit with each other are arranged between the rear end surface of the limiting cover and the front end surface of the heating element holder, where the locating portion is inserted in the locating groove. Fitting between the locating portion and the locating groove enhances stability of securing the limiting cover to the front end of the heating element holder, which prevents radial play of the limiting cover relative to the front end of the heating element holder.
7. The front end of the thermocouple is limited between the heating element holder and the limiting cover; the limiting cover allows for the thermocouple to be limited in the front-rear direction, which prevents front-rear play of the thermocouple during operating, enhances structural stability of the thermocouple, and thus enhances measurement accuracy of the thermocouple.

### BRIEF DESCRIPTION OF THE DRAWINGS

FIG. 1 is a structural schematic diagram of a heating element assembly according to a first implementation;

FIG. 2 is an exploded view of the heating element assembly according to the first implementation;

FIG. 3 is a local structural sectional view of the heating element assembly according to the first implementation;

FIG. 4 is a structural view of a heating element in the heating element assembly according to the first implementation;

FIG. 5 is a structural schematic diagram of a heating element holder in the heating element assembly according to the first implementation;

FIG. 6 is another structural schematic diagram of the heating element holder in the heating element assembly according to the first implementation;

FIG. 7 is a front-end structural schematic diagram where the heating element in the heating element assembly is disposed on the heating element holder according to the first implementation;

FIG. 8 is a structural schematic diagram of a limiting cover in the heating element assembly according to the first implementation;

FIG. 9 is a front view in which the limiting cover, the heating element holder, and the heating element are assembled together in the heating element assembly according to the first implementation;

FIG. 10 is a structural view of an insulating plate in the heating element assembly according to the first implementation;

FIG. 11 is a structural view of a hot air gun according to the first implementation;

FIG. 12 is a schematic diagram of an internal structure of the hot air gun according to the first implementation.

### REFERENCE NUMERALS

100—heating element assembly; 110—heating element holder; 111—mounting slot; 112—separation bar; 113—limiting recess; 114—recess; 115—through hole; 116—locating boss; 117—corner groove; 118—jack; 119—locating groove; 120—heating element; 121—heating body; 122—connection section; 123—power connection section; 130—air outlet cover; 131—air outlet; 140—limiting cover; 141—protrusion portion; 142—avoidance groove; 143—fastening hole; 144—locating portion; 150—thermocouple; 151—sensing portion; 160—insulating plate; 170—fastener; 171—fastening sheet; 181—ceramic sleeve; 182—mica sleeve; 183—metallic sleeve; 1831—flange; 1832—securing portion; 191—electrical conductive member; 192—electrical terminal; 193—fuse; 194—NTC protector; 200—housing; 300—electrical motor; 400—fan; 510—trigger; 520—adjuster; 600—controller module.

### DETAILED DESCRIPTION OF EMBODIMENTS

Hereinafter, the disclosure will be described in further detail through specific implementations with reference to the accompanying drawings. It is understood that, the orientational or positional relationships indicated by the terms “upper,” “lower,” “left,” “right,” “longitudinal,” “transverse,” “inner,” “outer,” “vertical,” “horizontal,” “top,” “bottom,” and the like are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

### First Embodiment

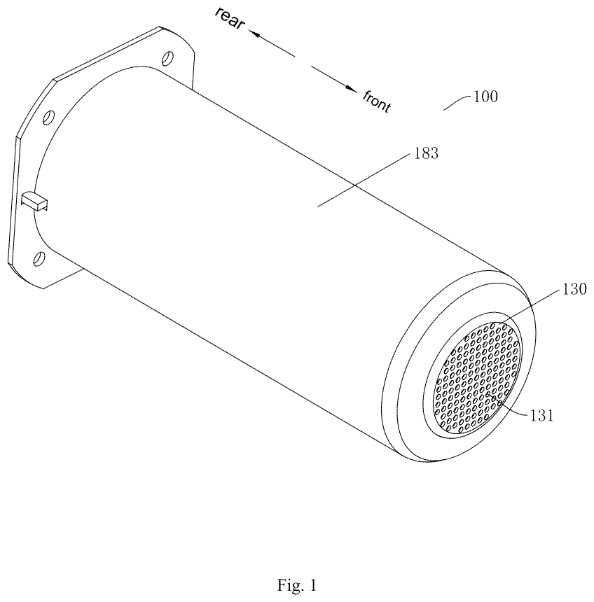

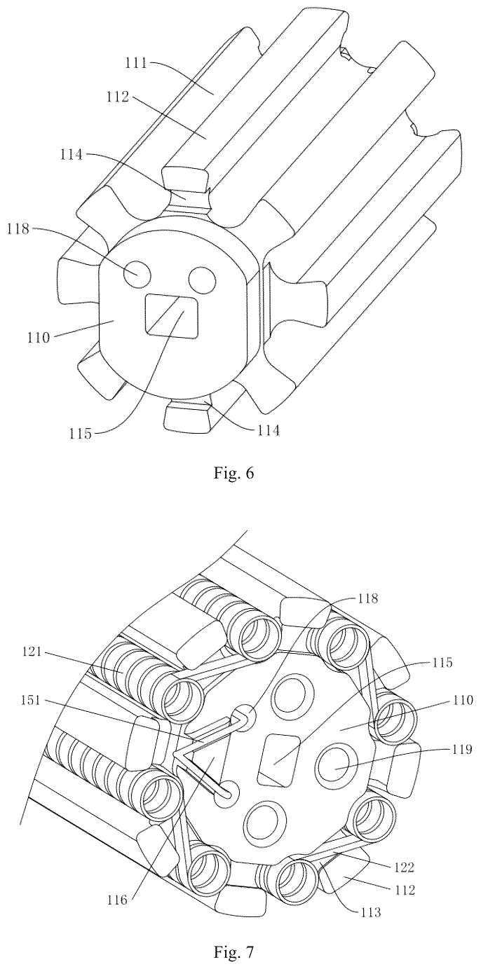

As illustrated in FIGS. 1 to 10, a heating element assembly 100 of a hot air gun according to a first implementation comprises a heating element holder 110, a heating element 120 arranged on the heating element holder 110, and an air outlet cover 130 disposed in front of the heating element holder 110; the heating element holder 110 is formed with a plurality of mounting slots 111 arranged at intervals along a circumferential direction; the heating element 120 comprises a plurality of segments of helical heating bodies 121 and connection sections 122 configured to connect respective neighboring two segments of heating bodies 121; the heating bodies 121 are disposed in the mounting slots 111 and at least some of the connection sections 122 are located at a front end of the heating element holder 110. The heating element assembly 100 further comprises a limiting cover 140 disposed at the front end of the heating element holder 110 and located rear to the air outlet cover 130, the limiting cover 140 being configured to limit the heating element 120.

The limiting cover 140 allows for the heating element 120 to be limited in a front-rear direction, which improves positional stability of the heating element 120 and prevents the heat-induced expanded heating element 120 from displacement to contact the air outlet cover 130 leading to an over high temperature of the air outlet cover 130, whereby a user would not be scalded in a case of accidentally touching the over hot air outlet cover 130, reducing safety hazards when operating the hot air gun, thereby enhancing use safety of the hot air gun.

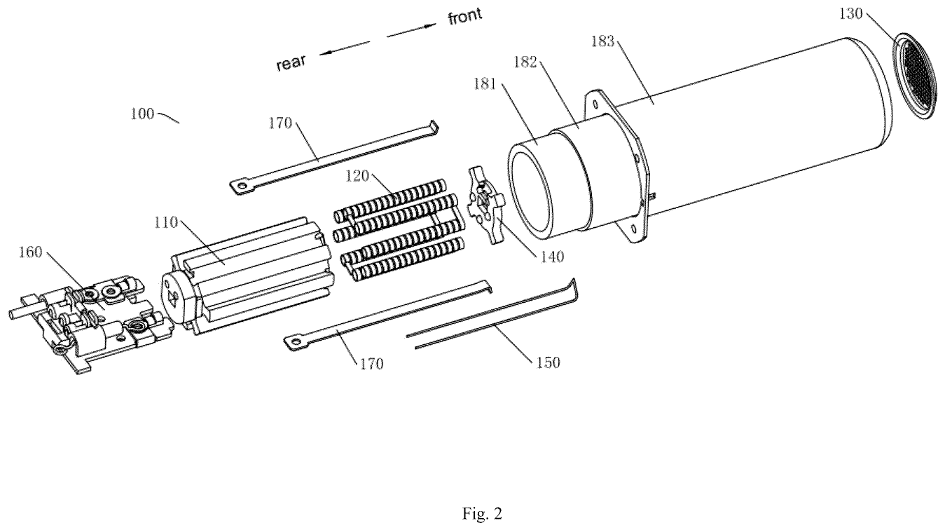

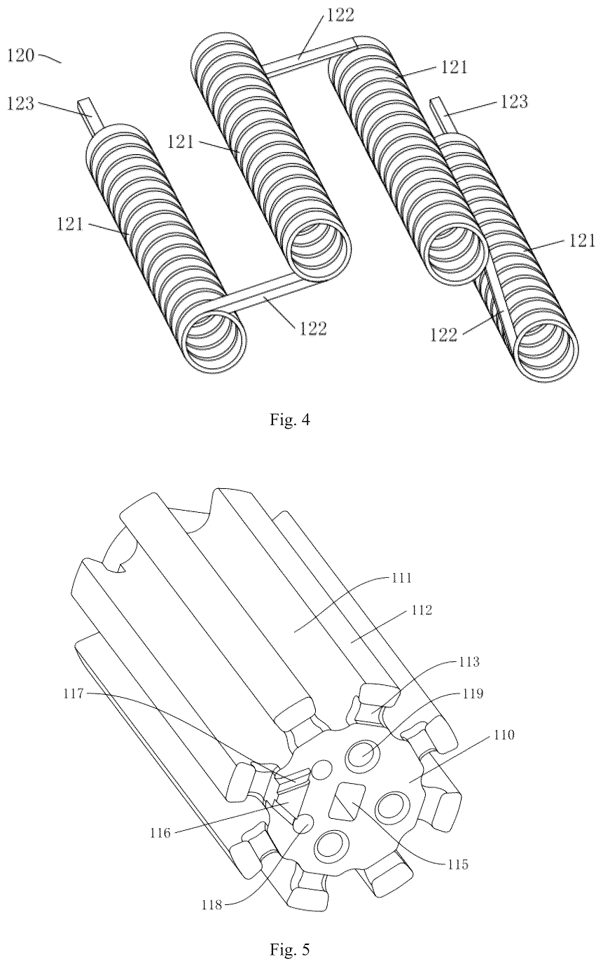

With reference to FIG. 5, in this implementation, the heating element holder 110 is formed with eight mounting slots 111 arranged at even intervals along the circumferential direction; correspondingly, eight separation bars 112 protruding outwardly are arranged in the circumferential direction of the heating element holder 110, each separation bar 112 serving to separate respective neighboring two mounting slots 111. With reference to FIGS. 2 and 4, two heating elements 120 are provided, each heating element 120 being provided with four parallel segments of helical heating bodies 121, a power connection section 123 being respectively arranged at rear ends of the leading and tail segments of heating bodies 121, respective neighboring two heating bodies 121 being connected via the connection sections 122. Each heating element 120 is provided with three connection sections 122, among which two connection sections 122 are located at the front end of the heating element holder 110 and one connection section 122 is located at the rear end of the heating element holder 110. It is understood that, the numbers of the mounting slots 111 and separation bars 112 provided for the heating element holder 110 are not limited to those described supra or to those illustrated in the drawings; instead, other reasonable numbers are also allowed. Correspondingly, the numbers of the heating bodies 121 and connection sections 122 provided on the heating element 120 are not limited to those described supra or to those illustrated in the drawings; instead, other reasonable numbers may be provided dependent on a specific structure of the heating element holder 110.

With reference to FIGS. 5, 6 and 7, in this implementation, a rearwardly recessed limiting recess 113 is formed at the front end of each separation bar 112, and a forwardly recessed recess 114 is formed at a rear end of some of the separation bars 112. The helical heating bodies 121 are disposed in the mounting slots 111; the connection sections 122 at the front end of the heating element holder 110 are caught in corresponding limiting recesses 113; the connection sections 122 at the rear end of the heating element holder 110 are caught in the corresponding recesses 114; fitting between the connection sections 122 at the front end and the limiting recesses 113 and fitting between the connection sections 122 at the rear end and the recesses 114 result in bidirectional limitation of the heating bodies 121 in a front-rear direction in the mounting slots 111, so that the heating bodies 121 do not easily slide in the mounting slots 111 in the front-rear direction.

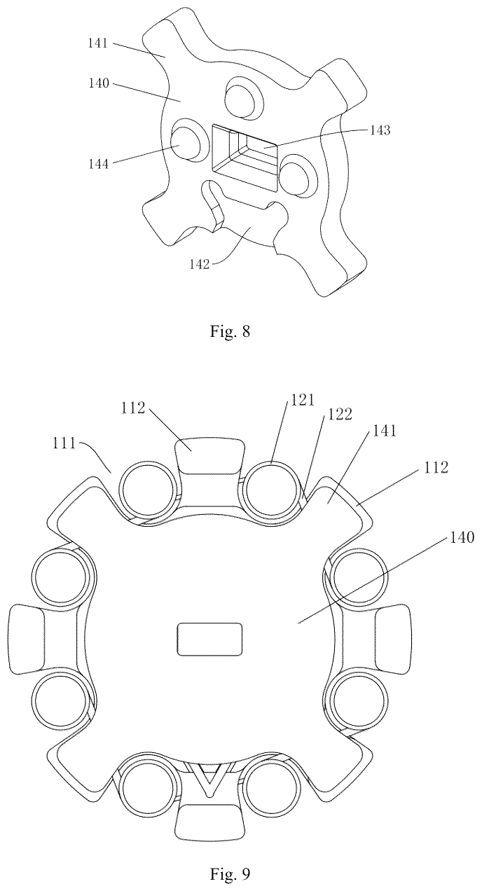

With reference to FIG. 8, in this implementation, the limiting cover 140 is preferably made of ceramics so as to satisfy relevant requirements; of course, the limiting cover 140 may also be made of other insulating materials that have a low coefficient of thermal conductivity. The limiting cover 140 is provided with protrusion portions 141 extending outwardly from the outer circumferential surface corresponding to respective connection sections 122 caught in the limiting recesses 113, the connection sections 122 at the front end of the heating element holder 110 being limited in the corresponding limiting recesses 113 by respective protrusion portions 141. Specifically, in this implementation, the limiting cover 140 is provided with four protrusion portions 141 extending outwardly, the four protrusion portions 141 being arranged substantially at even intervals along the circumferential direction of the limiting cover 140, the four protrusion portions 141 limiting the four connection sections 122 at the front end of the heating element holder 110 in the corresponding limiting recesses 113.

With reference to FIG. 9, to prevent the protrusion portions 141 from covering the mounting slots 111 blocking outlet of the stream of hot air, the projections of the protrusion portions 141 in the front-rear direction being located within the range of the projections of the separation bars 112 in the front-rear direction, i.e., the outwardly-extended heights of the protrusion portions 141 are less than the outward-protruded heights of the separation bars 112; moreover, the widths of the protrusion portions 141 are less than the widths of the separation bars 112, so that the outer contour lines of the protrusion portions 141 do not extend beyond the outer contour lines of the separation bars 112, which prevents the protrusion portions 141 from projecting into the extent of the projections of the mounting slots 111 in the front-rear direction.

With reference to FIGS. 2 and 7, to detect the outlet air temperature of the heating element assembly 100, the heating element assembly 100 further comprises a thermocouple 150 extending through the heating element holder 110, a front end of the thermocouple 150 being limited between the heating element holder 110 and the limiting cover 140 and projecting outwardly beyond the limiting cover 140. With reference to FIG. 5, in this implementation, the front end of the thermocouple 150 is provided with a substantially V-shaped sensing portion 151, a front end surface of the heating element holder 110 is provided with a substantially trapezoidal locating boss 116 that protrudes forwardly, two opposing sides of the locating boss 116 being respectively formed with a corner groove 117 configured to avoid the sensing portion 151, the sensing portion 151 abutting against the locating boss 116 and being located at the corner groove 117. With reference to FIG. 8, the limiting cover 140 is provided with an avoidance groove 142 that is configured to avoid the locating boss 116 and the sensing portion 151, the avoidance groove 142 extending forward a certain depth from the rear end surface of the limiting cover 140, the sensing portion 151 of the thermocouple 150 being limited between the locating boss 116 and the inner wall of the avoidance groove 142, a tip end of the sensing portion 151 extending out of the limiting cover 140 and being located at the front end of a corresponding mounting slot 111; the heating element holder 110 is provided with two jacks 118 extending axially to fit with the thermocouple 150, two legs of the thermocouple 150 being inserted in the two jacks 118 and projecting rearwardly out of the heating element holder 110, respectively.

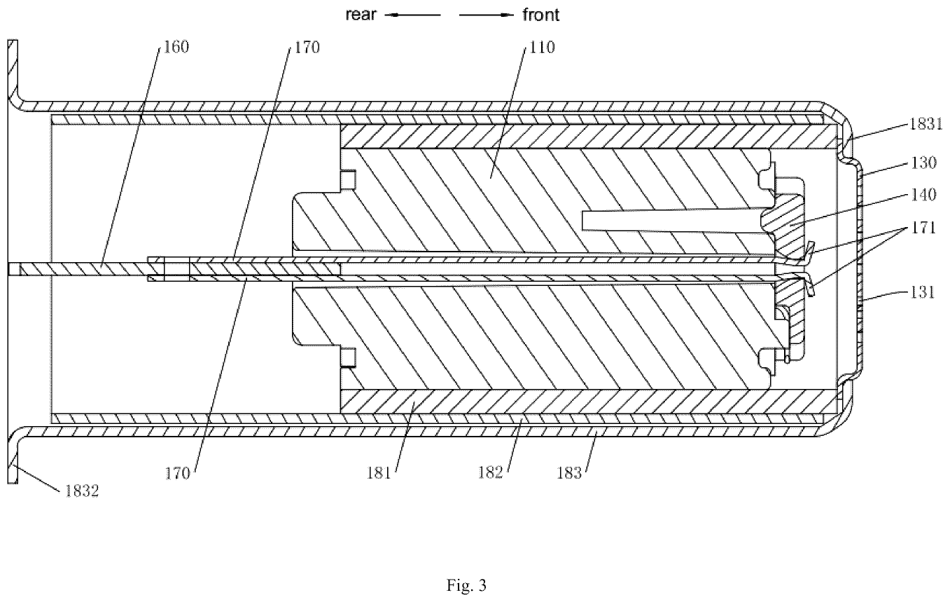

With reference to FIGS. 2 and 3, the heating element assembly 100 further comprises an insulating plate 160 secured to the rear end of the heating element holder 110, the limiting cover 140 being securely connected to the insulating plate 160 via a fastener 170. Specifically, a through hole 115 extending in a front-rear direction is formed in the center of the heating element holder 110, and the limiting cover 140 is formed with a fastening hole 143 corresponding to the through hole 115. The fastener 170 has an elongated shape. In this implementation, two fasteners 170 are symmetrically arranged about the planar direction of the insulating plate 160. The elongated fasteners 170 are inserted in the through hole 115. Respective rear ends of the two fasteners 170 are securely connected to the insulating plate 160 via a connector such as a screw or a rivet. A rear surface of the limiting cover 140 and a front surface of the heating element holder 110 are substantially conformingly fitted. Respective front ends of the two fasteners 170 project forwardly from the fastening hole 143 and are bent to form fastening sheets 171, the fastening sheets 171 abutting against the front surface of the limiting cover 140 so that the limiting cover 140 is limited in the front-rear direction and then secured to the front end of the heating element holder 110.

With reference to FIGS. 5 and 8, to ensure structural stability of the limiting cover 140, a locating portion 144 is provided at one of the rear end surface of the limiting cover 140 and the front end surface of the heating element holder 110, and a locating groove 119 fitted with the locating portion 144 is provided at the other of the rear end surface of the limiting cover 140 and the front end surface of the heating element holder 110, the locating portion 144 being inserted in the locating groove 119; fitting between the locating portion 144 and the locating groove 119 prevents radial play of the limiting cover 140 relative to the front end of the heating element holder 110. In this implementation, the locating portion 144 projects rearwardly from the rear end surface of the limiting cover 140, where a plurality of locating portions 144 are arranged at intervals. The locating portions 144 are specifically locating protrusions; a plurality of the locating grooves 119 extend rearwardly from the front end surface of the heating element holder 110 and are distributed in one-to-one correspondence with respective locating portions 144. When the limiting cover 140 is secured to the front end of the heating element holder 110 via the fastener 170, the locating portions 144 are inserted into corresponding locating grooves 119. Fitting between the locating portions 144 and the locating grooves 119 not only limits the limiting cover 140 in the radial direction but also realizes fool-proofing when mounting the limiting cover 140. It is understood that, specific structures of the locating portion 144 and the locating groove 119 are not limited to those described supra or to those illustrated in the accompanying drawings, where the locating portion 144 may be formed of other reasonable shapes such as a bar-shaped locating rib or a locating stud; correspondingly, the shape of the locating groove 119 is matched with the shape of the locating portion 144. In addition, the positions of the locating portion 144 and the position of the locating groove 119 may be swapped with each other, i.e., if the locating portion 144 is arranged on the front end surface of the heating element holder 110, the locating groove 119 is arranged on the rear end surface of the limiting cover 140.

With reference to FIGS. 2 and 3, the heating element assembly 100 further comprises a ceramic sleeve 181 sleeved outside the heating element holder 110, a mica sleeve 182 sleeved outside the ceramic sleeve 181, and a metallic sleeve 183 sleeved outside the mica sleeve 182, a circle of flange 1831 being arranged at a front end of the metallic sleeve 183, an outer edge of the air outlet cover 130 being tightly clamped between the flange 1831 and a front end of the mica sleeve 182, a plurality of air outlets 131 arranged at intervals being formed on the air outlet cover 130.

With reference to FIG. 3, the axial length of the ceramic sleeve 181 is slightly greater than the axial length of the heating element holder 110, the front end of the ceramic sleeve 181 extends forward beyond the front end of the heating element holder 110, and the limiting cover 140 is disposed in the ceramic sleeve 181, the limiting cover being spaced from the air outlet cover 130 with an interval in the front-rear direction. The axial length of the mica sleeve 182 is greater than the axial length of the ceramic sleeve 181, and the rear end of the mica sleeve 182 extends rearwardly beyond the rear end of the ceramic sleeve 181. The axial length of the metallic sleeve 183 is slightly greater than the axial length of the mica sleeve 182, the rear end of the metallic sleeve 183 extends rearwardly beyond the rear end of the mica sleeve 182, the rear end of the metallic sleeve 183 is provided with a securing portion 1832 extending outwardly, and the insulating plate 160 is secured to the rear end of the metallic sleeve 183.

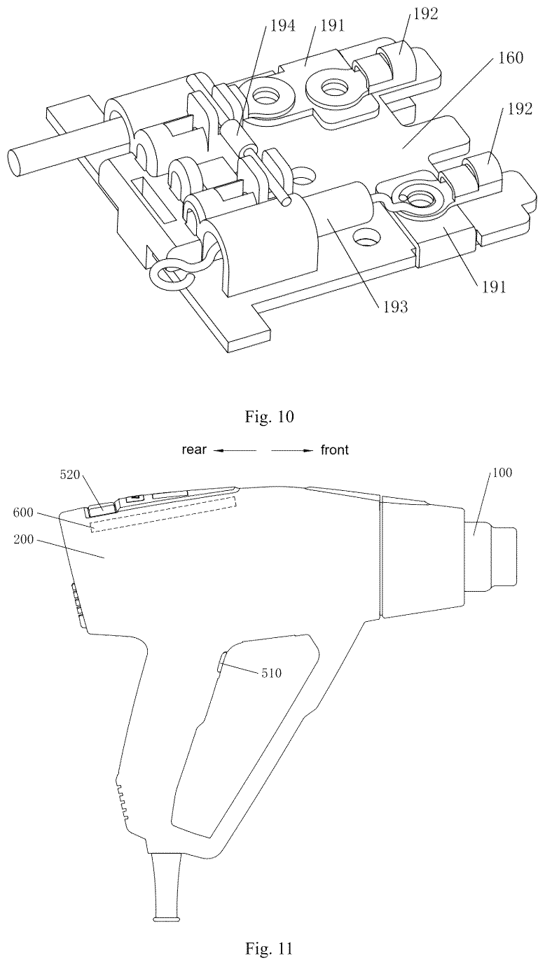

With reference to FIG. 10, two groups of electrical terminals 192 are secured on the insulating plate 160 via two electrical conductive members 191, one group of the electrical terminals 192 being connected to a positive wire, the other group thereof being connected to a negative wire, one power connection section 123 of the two heating elements 120 being electrically connected to the group of positive electrical terminals 192, the other power connection section 123 being electrically connected to the group of negative electrical terminals 123, the positive wire and the negative wire being electrically connected to the two electrical conductive members 191, respectively, whereby the heating elements 120 are connected to a power supply circuit.

The heating element assembly 100 further comprises a NTC (Negative Temperature Coefficient) protector 194 arranged on the insulating plate 160, the NTC protector 194 being parallel connected to the heating element 120 so as to adjust energization current of the heating element 120.

To prevent safety hazards caused by continued heating of the over hot heating element 120 in a case of temperature adjustment failure, a fuse 193 is connected on the positive wire or on the negative wire, the fuse 193 being connected in series to the heating element 120, so that the fuse 193, once being blown, causes the heating element 120 to be open-circuited, preventing continued heating of the heating element 120.

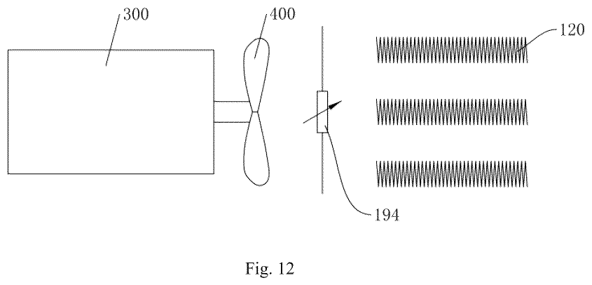

With reference to FIGS. 11 and 12, this implementation further provides a hot air gun, comprising a housing 200, an electric motor 300, a fan 400, and the heating element assembly 100 described supra, the electric motor 300, the fan 400, and the heating element assembly 100 being arranged in the housing 200 in a direction from rear to front, a front end of the heating element assembly 100 extending out of the housing 200, the fan 400 being actuated by the electric motor 300, a trigger 510 configured to activate the hot air gun and an adjuster 520 configured to adjust air outlet temperature being arranged on the housing 200, a controller module 600 being arranged in the housing 200, a thermocouple 150 being in signal connection with the controller module 600. It is understood that, the hot air gun may be powered by a battery or by the mains electricity via an electrical wire. It is understood that, a specific structure of the hot air gun is not limited to that illustrated in the drawings, and other structural patterns are also allowed

The following describes how the hot air gun works. The heating element 120 is energized to produce heat, and the electric motor 300 actuates the fan 400 to rotate to create an air stream flowing from rear to front, so that the air stream is heated after flowing through the heating element 120 to form a stream of hot air flowing forwardly out of the air outlet cover 130. During operating of the hot air gun, the thermocouple 150 measures air outlet temperature of the stream of hot air and feeds it to the controller module 600, whereby the controller module 600 adjusts the air outlet temperature. If an anomaly such as stalling of the electric motor 300, blockage of the air inlet, and blockage of the air outlet occurs during operating of the hot air gun, the energization current of the heating element 120 may be cut off via resistance change of the NTC protector 194, causing the heating element 120 to suspend heating, thereby preventing the hot air gun from being broken due to overheat.

Besides the specific implementations described supra, the disclosure further has other implementations; those skilled in the art may make various changes and modifications according to the disclosure, and all of such changes and modifications fall within the scope defined in the appended claims without departing from the spirits of the disclosure.

1. A heating element assembly of a hot air gun, comprising a heating element holder, a heating element disposed on the heating element holder, and an air outlet cover arranged in front of the heating element holder, the heating element holder being provided with a plurality of mounting slots distributed at intervals along a circumferential direction, the heating element comprising a plurality of segments of helical heating bodies and connection sections configured to connect respective neighboring two segments of heating bodies, the heating bodies being disposed in respective mounting slots, at least some of the connection sections being disposed at a front end of the heating element holder, wherein the heating element assembly further comprises a limiting cover disposed at the front end of the heating element holder and located rear to the air outlet cover, the limiting cover being configured to limit the heating element.

2. The heating element assembly of a hot air gun according to claim 1, wherein the limiting cover is provided with protrusion portions extending outwardly, and the connection sections disposed at the front end of the heating element holder are limited between respective protrusion portions and the front end of the heating element holder.

3. The heating element assembly of a hot air gun according to claim 2, wherein the heating element holder is provided with separation bars arranged between respective neighboring two mounting slots, a front end of each separation bar being formed with a rearwardly recessed limiting recess, and the connection sections at the front end of the heating element holder are limited in corresponding limiting recesses by respective protrusion portions.

4. The heating element assembly of a hot air gun according to claim 3, wherein a projection of each protrusion portion in a front-rear direction is located within a range of a projection of the corresponding separation bar in a front-rear direction.

5. The heating element assembly of a hot air gun according to claim 1, wherein the heating element assembly further comprises an insulating plate secured to a rear end of the heating element holder, the limiting cover being secured to the insulating plate via a fastener.

6. The heating element assembly of a hot air gun according to claim 5, wherein a through hole is formed in the center of the heating element holder, and the limiting cover is formed with a fastening hole corresponding to the through hole, the fastener being inserted in the through hole, a rear end of the fastener being secured to the insulating plate, and a front end of the fastener passing through the fastening hole and being bent to abut against the limiting cover.

7. The heating element assembly of a hot air gun according to claim 1, wherein a locating portion is provided at one of a rear end surface of the limiting cover and a front end surface of the heating element holder, and a locating groove fitted with the locating portion is provided at the other one of the rear end surface of the limiting cover and the front end surface of the heating element holder, the locating portion being inserted in the locating groove.

8. The heating element assembly of a hot air gun according to claim 1, wherein the heating element assembly comprises a thermocouple extending through the heating element holder, a front end of the thermocouple being limited between the heating element holder and the limiting cover and extending outwardly beyond the limiting cover.

9. The heating element assembly of a hot air gun according to claim 1, wherein the heating element assembly further comprises a fuse connected in series to the heating element; and/or, the heating element assembly further comprises a Negative Temperature Coefficient NTC protector.

10. A hot air gun, comprising an electric motor and a fan, the electric motor and the fan being disposed in a housing, the fan being actuated by the electric motor, wherein the hot air gun further comprises the heating element assembly according to claim 1, the heating element assembly being disposed in the housing and located in front of the fan.
